(19) United States
(12) Patent Application Publication
(10) Pub. No.: US 2007/0095960 A1
(43) Pub. Date: May 3, 2007

(54) Paper shredder cutting tool

(76) Inventor: Emily Lo, Hsin Chuang City (TW)

Correspondence Address: PRO-TECHTOR INTERNATIONAL SERVICES, 20775 NORADA CT., SARATOGA, CA, 95070, US

(21) Appl. No.: 11/264,867

(22) Filed: Nov. 1, 2005

(51) Int. Cl. B02C 18/16

(52) U.S. Cl. 241/236; 241/295

(57) ABSTRACT

A paper shredder cutting tool according to the present invention includes two sets of rolling blades that are parallel and side-by-side to each other. Wherein, several blade modules are configured correspondingly. Each blade module is consisted of a smooth first plate-shaped blade and an adjacent curved second plate-shaped blade to form the circumferences of the blade modules as asymmetrical blade tips for slicing the papers into asymmetrical and small pieces. Furthermore, the curved side of the blade tip is non-parallel to paper input direction to provide dragging effects and thus preventing paper jam.

### BACKGROUND OF THE INVENTION

(a) Field of the Invention

The present invention relates to a paper shredder cutting tool that is easily manufactured, effectively avoids paper jam, and reduces legibility of contents of shredded paper pieces.

(b) Description of the Prior Art

Referring to FIG. 1, a conventional paper shredder cutting tool has cutting tools that are constructed to include two cylindrical rotary cutters 10 and 10′. Each of the rotary cutters 10 and 10′ is mounted on a polygonal shaft 12, and a plurality of cutting blades 14 is securely mounted on the shafts 12. A paper guide 16 is configured between each pair of adjacent cutting blades 14, thus partitioning the cutting blades 14 therebetween, and thereby allowing the cutting blades 14 to be assembled and mounted in an interleaving fashion on the two cylindrical rotary cutters 10 and 10′. Moreover, each of the cutting blades 14 is further constructed from a pair of blades, and the protruding cutting blades 18 are configured to circumferences thereof.

As shown in FIG. 1 and FIG. 2, a motor 100 of the cutting tool is the main driving component. A decelerator 200 joints the shafts 12 of two sets of rolling blades 10 and 10′ with the motor 100. Two sets of rolling blades 10 and 10′ perform reciprocal rolling motions driven by the motor 100 to shred papers passing through into pieces.

The aforesaid configuration of the conventional paper shredder cutting tool can indeed shred papers into pieces. However, using the principle of the configuration of the interlaced cutting blades 14 slicing papers into strips, and the protruding cutting blades 18 configured on the circumferences of the cutting blades 14 cutting strips of the papers to pieces, thickness of the papers to be shredded is limited by the height of the protruding cutting blades 18, and the width of the shredded pieces is considerably wide. In other words, contents of the shredded pieces are more likely to be legible; thus, contents of the documents may be exposed to undesirably fail the purpose of shredding the documents.

Furthermore, tips of the cutting blades 14 move in parallel to the paper input direction to worse dragging effects. Paper jam can easily occur resulted from paper pieces piled up during the operation.

Taking the aforesaid issues into consideration, the present invention enhances the conventional paper shredder cutting tool by providing a cutting tool that is easily manufactured and convenient, while effectively avoids paper jam and reduces legibility of contents of shredded paper pieces.

### SUMMARY OF THE INVENTION

The primary object of the invention is to provide a paper shredder cutting tool that is easily manufactured, effectively avoids paper jam and reduces legibility of contents of shredded paper pieces.

### BRIEF DESCRIPTION OF THE DRAWINGS

FIG. 1 shows an elevational schematic view of a conventional paper shredder cutting tool.

FIG. 2 shows a top view of a conventional paper shredder cutting tool.

FIG. 3 shows a structural top view of the cutting tool according to the present invention.

FIG. 4 shows a shape of a of a shredded paper piece according to the present invention.

FIG. 5 shows another shape of a shredded paper piece according to the present invention.

FIG. 6 shows a structural sectional view of one tip of a blade in a blade module according to the invention.

FIG. 7 shows a structural sectional view of two tips of a blade in a blade module according to the invention.

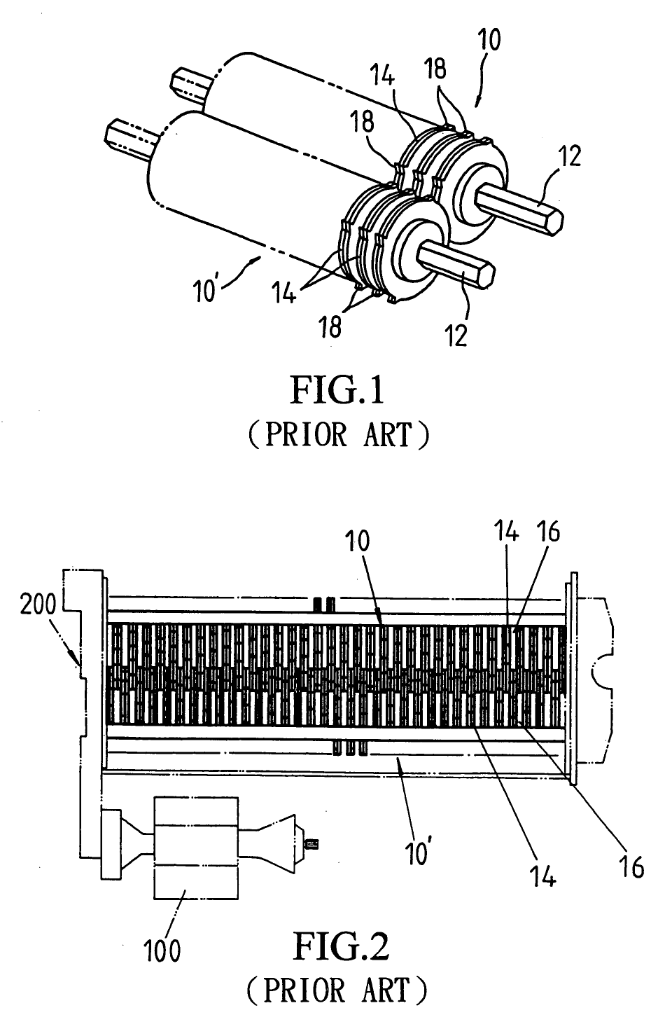

### DETAILED DESCRIPTION OF THE PREFERRED EMBODIMENTS

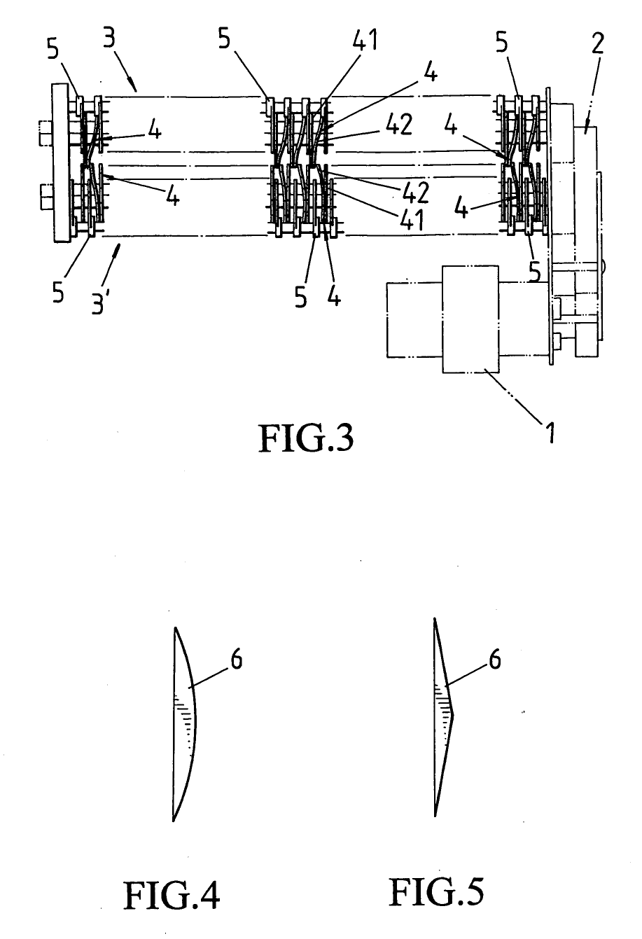

According to FIG. 3, the invention consists of two sets of parallel cylindrical rolling blades 3 and 3′ side-by-side, a motor 1 as main driving component and a decelerator 2 jointing the rolling blades 3 and 3′ with the motor 1. Driven by the motor 1, two sets of rolling blades 3 and 3′ perform reciprocal turning motions to shred the papers passing through into asymmetrical small pieces 6 as shown in FIG. 4 and FIG. 5.

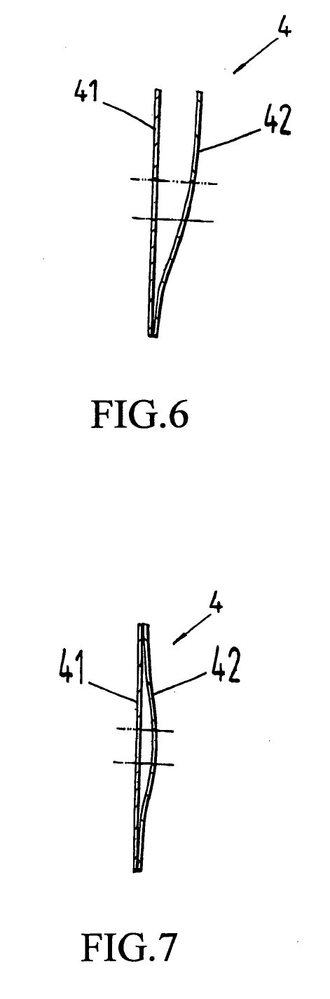

The invention is characterized in that, several blade modules 4 are configured correspondingly in two sets of rolling blades 3 and 3′. Referring to FIG. 6 and FIG. 7, each blade module 4 comprises a straight first plate-shaped blade 41 and an adjacent curved second plate-shaped blade 42 to form asymmetrical blade tips with one straight side and one curved side thereof.

During operation, the second plate-shaped blade can be formed as a slightly curved shape or a more obvious curved shape through stamping process with characteristics of easy manufacturing. Furthermore, a polygonal axle center aperture is respectively configured on the first and second plate-shaped blades of each blade module. Wherein, the number of sides of the axle center aperture is at least two more than that of the axle shaft going through. A plurality of acute protruding cutting blades is respectively configured at the circumferences of the first and second plate-shaped blades. Each protruding cutting blade is configured in unequal azimuths. When the first and second plate-shaped blades are assembled adjacently, a fixed angle is formed by corresponding protruding cutting blades of the first and second plate-shaped blades.

According to FIG. 3, a paper guiding piece 5 for partitioning is configured between the blade modules 4, so as to arrange the blade modules 4 on two sets of rolling blades 3 and 3′ in an interlacing fashion. When two sets of rolling blades 3 and 3′ turn reciprocally, the blade modules 4 thereof cut the shredded papers off by jointing tips of the blades.

Resultingly, the papers can be cut into asymmetrical small pieces 6 as in FIG. 4 and FIG. 5. The small piece 6 in FIG. 4 is cut by the second plate-shaped blade with the slightly curved shape, and the small piece 6 in FIG. 5 is cut by the second plate-shaped blade with the obvious curved shape. The legibility of the contents are reduced because tips of the small pieces are in acute angles and the small pieces are in a shape with asymmetrical sides.

During operation, the curved side of the blade tip is non-parallel to paper input direction to provide dragging effects and thus preventing paper jam. Moreover, the blade tips of the rolling blades can be configured in a spiral fashion to avoid all blades and tips of the blades falling on the same axle to fuirther disperse stress during paper shredding motion, thereby improving durability of the blades and minimizing possible damages of the paper shredder.

What is claimed is:

1. A paper shredder cutting tool comprising two sets of parallel rolling blades side-by-side wherein:
a plurality of blade modules of two sets of rolling blades correspondingly configured, wherein each blade module is consisted of a straight first plate-shaped blade and an adjacent curved second plate-shaped blade a circumference of each blade module, thereby forming an asymmetrical blade tip and shredding papers into small pieces asymmetrically.

2. The paper shredder cutting tool in accordance with claim 1, wherein the second plate-shaped blade is a slightly curved shape.

3. The paper shredder cutting tool in accordance with claim 1, wherein the second plate-shaped blade is an obvious curved shape.
